(19) United States
(12) Patent Application Publication
(10) Pub. No.: US 2009/0150921 A1
(43) Pub. Date: Jun. 11, 2009

(54) SYSTEM AND METHOD FOR REVIEWING DIGITAL CINEMA CONTENT

(75) Inventors: John Robert Naylor, Lake Oswego, OR (US); James Edward Pearce, Hampshire (GB); Ginhann Liu, Portland, OR (US)

Correspondence Address: Thomson Licensing LLC, P.O. Box 5312, Two Independence Way, PRINCETON, NJ, 08543-5312, US

(73) Assignee: THOMAS LICENSING, Boulogne-Billancourt (FR)

(21) Appl. No.: 11/990,152

(22) PCT Filed: Feb. 24, 2006
(86) PCT No.: PCT/US2006/006617

§ 371 Date: Feb. 7, 2008

Related U.S. Application Data
(60) Provisional application No. 60/707,018, filed on Aug. 10, 2005.

(51) Int. Cl. H04N 7/173

(52) U.S. Cl. 725/24

(57) ABSTRACT

A system and method for reviewing and checking cinema movies for completeness and conformity with exhibitor expectations in a time-saving and efficient manner. In one embodiment, a method for evaluating presentations is provided wherein for each presentation length, a reel time duration X is determined, points of interest are determined, and presentation length portions to be evaluated are selected as preferably including at least a duration of time which includes each of the determined points of interest. The selected portions may include a buffer portion, e.g., a period of time from about 5% of the total presentation length time before to about 5% of the total presentation length time after each of the determined points of interest. Another portion may be presentation length selected for evaluation which includes at least 10% of the total presentation length time. Such 10% selected portion is preferably selected from the center of each presentation length.

### CROSS REFERENCE TO RELATED APPLICATIONS

This application is related to U.S. Provisional Patent Application Ser. No. 60/707,018, entitled “TIMESAVING QUALITY CONTROL SYSTEM FOR DIGITAL CINEMA”, filed Aug. 10, 2005, which is incorporated by reference herein in its entirety.

### TECHNICAL FIELD OF THE INVENTION

The present invention generally relates to digital cinema and, more particularly, to a system and method for quality control review and assessment of digital cinema content comprising, e.g., digital cinema movies.

### BACKGROUND OF THE INVENTION

Typically, before a movie may be released in theaters for presentation to audiences, it must first be reviewed and edited for content. At present, the reviewing process of traditional film-based movies typically requires someone to watch and listen to the entire movie to make sure that the images and audio are free of problems or scenes that an audience would find objectionable. Obviously this process takes at least as long as the time duration of the movie.

It is noted that in other fields, such as television production and broadcast, content can be reviewed via inspection of samples (e.g., by examining a subset of the content). Such methods of quality control (QC) can be achieved by:

1. Fast forward—play and review the content at, say, ten times normal speed.

2. Selective sampling—play a short segment of the material, jump ahead by a few minutes, play another short segment, etc.

The first mode of QC can be used for, e.g., tape based content, and tape machines that support fast-forward playout. Although the second mode is possible on tape based equipment, it is particularly suited to disk-based media systems.

The film projectors used in cinemas support neither of these modes of operation. However, specialist projectors are available that support the second mode and are utilized in movie production and post production for viewing dailies.

Currently, movie distribution and exhibition techniques are in transition from using film as the distribution and exhibition medium to using digital media distributed as computer files and exhibited using digital cinema playout servers, digital projectors and audio processors. With advances in digital cinema, film will eventually be replaced by digital cinema movies as a distribution medium.

Such Digital Cinema movies conform to a standard format whereby the movie is broken into short “reels”. Each reel lasts approximately 10 minutes and contains all the files necessary to reproduce that particular segment of the movie (i.e. an images file, multiple audio files, subtitles file, etc). The current state-of-the-art, which requires the person reviewing/testing the presentation to watch and listen to the entire movie end to end, is tedious and time-consuming. Accordingly, a quicker, more efficient method of reviewing Digital Cinema movies would be highly desirable.

### SUMMARY

The present invention provides a system and method for reviewing and checking digital cinema movies for completeness and conformity with exhibitor expectations in a time-saving and efficient manner having improved convenience and efficiency that overcomes the limitations of the prior art.

In one aspect, a method for evaluating a digital cinema presentation comprising a plurality of reels is provided comprising the steps of determining a total reel time duration in X minutes for each reel, determining points of interest for the presentation and evaluating reel portions comprising at least a time duration of each point of interest.

In another aspect, the present invention provides a method for evaluating a digital cinema presentation comprised of a plurality of reels, the method comprising the steps of determining a total reel time duration in X minutes for at least one of the plurality of reels, determining points of interest for the reel and evaluating reel portions comprising at least a time duration of each point of interest of the reel.

In yet another aspect, the present invention provides a method for evaluating a digital cinema presentation comprising a plurality of reels, the method comprising the steps of determining a total reel time duration in X minutes for each reel, determining points of interest for the presentation, wherein the points of interest include at least one of a reel transition, an automation event, and an extreme event, evaluating point of interest reel portions comprising at least a time duration of each point of interest and a buffer portion before and after each point of interest and evaluating a center reel portion, wherein the center reel portion comprises a duration of time substantially in the center of each reel.

These, and other aspects, features and advantages of the present invention will be described or become apparent from the following detailed description of the preferred embodiments, which is to be read in connection with the accompanying drawings.

### BRIEF DESCRIPTION OF THE DRAWINGS

In the drawings, wherein like reference numerals denote similar elements throughout the views:

FIG. 1 is a schematic diagram of an exemplary digital cinema movie comprised of a plurality of reels.

FIG. 2 illustrates an exemplary diagram of reels showing portions requiring actual viewing for quality control according to an aspect of the present invention.

FIG. 3 is a flowchart of an exemplary method for evaluating digital cinema presentations according to an aspect of the present invention.

It should be understood that the drawings are for purposes of illustrating the concepts of the invention and are not necessarily the only possible configuration for illustrating the invention.

### DETAILED DESCRIPTION OF PREFERRED EMBODIMENTS

The present invention provides a system and method for reviewing and checking digital cinema movies for completeness and conformity with exhibitor expectations in a time-saving and efficient manner.

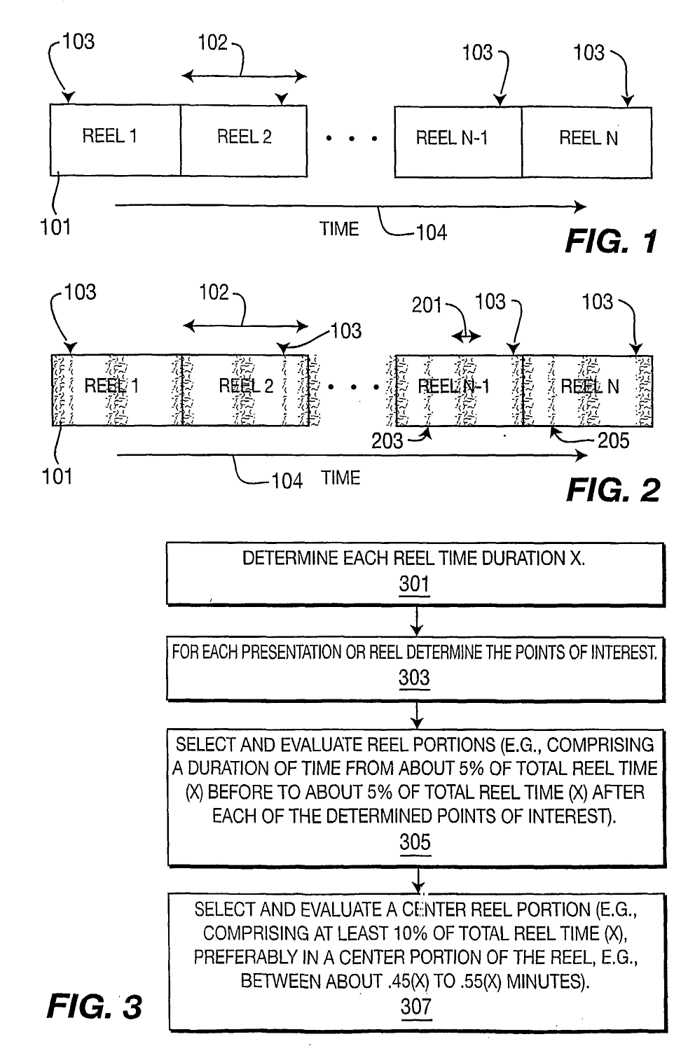

FIG. 1 is a schematic diagram of an exemplary digital cinema movie broken into a plurality of reels 101 each having a reel time duration 102, wherein the total of all the reel times 102 of reels 1 to reel N is equal to the total movie time duration 104. For example, each digital cinema reel 101 may have a reel time duration 102 of approximately 10 minutes and preferably includes all the computer files necessary to reproduce (visually, aurally, etc.) that particular segment of the movie. For example, each reel 101 may include an images file, multiple audio files, a subtitles file, etc.

Each reel 101 may include an indicator 103 which represents automation events that are part of the movie composition which instruct the system to perform actions such as: dim the lights to 50%, open curtains, set lights to emergency levels, increase lights to full, close curtains etc.

Advantageously, the present invention provides a time-saving automatic quality control system and method that allows digital cinema movies to be checked for quality control, completeness and conformity with exhibitor expectations much faster than current methods. For example, the present invention facilitates quality control of digital cinema movies approximately four times faster than permitted by current methods. To illustrate, for a typical two (2) hour movie, a manual quality control check takes a minimum of about two (2) hours or more. Using a system and method according to the present invention, however, the quality control review could be performed for such a movie in only about 25 minutes.

FIG. 2 is an exemplary diagram of the reels of FIG. 1 showing portions 201 requiring actual viewing for quality control according to an aspect of the present invention. Instead of requiring a tester to sit through each reel 101 through their entire reel time duration 102, the tester is only required to view the selected portions 201. Preferably, the selected portions 201 may comprise, e.g., transitions between reels, automation triggers, extreme parts of the movie (e.g., a quietest point 203 and/or a loudest point 205, etc.) and/or ‘confidence-building samples’ 201—e.g., a duration of time in a center of each reel. Preferably, the total duration of time of all the points of interest does not exceed the total time duration of the movie presentation. Indeed, note that the total duration of time required to sit through all of the selected portions 201 is much less than the total time 104 of the entire presentation.

Advantageously, the present invention utilizes the digital cinema playout system's knowledge of the structure and content of the movie presentation to focus attention on certain parts of the presentation that, e.g., may be of value from a quality control perspective. Thus, the present invention provides a highly efficient yet effective method for performing quality control on digital cinema movies.

FIG. 3 is a flowchart of an exemplary method for evaluating digital cinema presentations according to an aspect of the present invention. In step 301, at least one reel from a plurality of reels is evaluated to determine each reel time duration, e.g., in X minutes. For each digital cinema presentation (or for at least one reel), at least the following points of interest are preferably determined: reel transitions, automation events and ‘extreme’ events (step 303). Such extreme events may comprise, e.g., points of auditory extreme, such as the loudest and/or quietest points of the overall movie presentation. Other points of interest may be contemplated, however, it is preferable that the total time duration of all the determined points of interest is less than the total time duration of the digital cinema presentation.

The selected reel portions to be evaluated (step 305) preferably comprise a duration of time which includes at least each of the points of interest as determined in step 303. The selected portions may preferably further include buffer portions as well, e.g., the buffer may comprise an additional period of time before and after each point of interest. Thus, in one embodiment, for example, a selected reel portion may comprise a period of time from about 5% of the total reel time X before, to about 5% of the total reel time X after, each of the determined points of interest. That is, the selected reel portion may comprise:

from about (0.05(X) minutes prior to a point of interest) to about (0.05(X) minutes after the point of interest).

Preferably, another portion may be selected for evaluation comprising at least 10% of the total reel time X. Such 10% selected portion is preferably selected from the center of each reel. For example, for a reel having a reel time duration of X minutes, the ‘center’ portion of the reel may comprise a time duration from between about 0.45(X) to about 0.55(X) minutes of each reel (e.g., in a 10 minute reel, the center portion comprises from between about 4.5 minutes to about 5.5 minutes of each reel).

In one example using typical figures of a two (2) hour movie broken into twelve reels of ten (10) minutes duration each, a method for quality control implemented according to an aspect of the present invention results in the evaluation of the following:

review reel sections comprising about 30 seconds before to about 30 seconds after each reel transition;

review a one minute section in the center of each reel;

review reel sections comprising from about 30 seconds before to about 30 seconds after each automation event; and

review reel sections comprising from about 30 seconds before to about 30 seconds after each of the loudest and quietest parts of the presentation.

In the above example, the total amount of time needed for reviewing a two hour digital cinema presentation is only approximately 25 minutes—over four times faster than permitted by current methods.

Although the embodiment which incorporates the teachings of the present invention has been shown and described in detail herein, those skilled in the art can readily devise many other varied embodiments that still incorporate these teachings. Having described preferred embodiments for a system and method for reviewing and evaluating digital cinema movies for conformity with exhibitor expectations in a time-saving and efficient manner (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A method for evaluating a presentation comprising a plurality of presentation lengths comprising the steps of:
determining points of interest for the presentation; and
evaluating presentation length portions comprising at least a time duration of each point of interest.

2. The method of claim 1, wherein the points of interest include at least one of presentation length transitions, automation events, and an extreme event.

3. The method of claim 2, wherein the extreme event comprises a loudest audio point and a quietest audio point.

4. The method of claim 1, further comprising the step of evaluating a center presentation length portion.

5. The method of claim 4, wherein the center presentation length portion comprises a duration of time from between about 0.45(X) minutes to about 0.55(X) minutes of each presentation length.

6. The method of claim 1, wherein the presentation length portions include a buffer portion before and after each point of interest.

7. The method of claim 1, wherein the presentation length portion comprises a duration of time from about 0.05(X) minutes prior to the point of interest to about 0.05(X) minutes after the point of interest.

8. A method for evaluating a presentation comprised of a plurality of presentation lengths, comprising the steps of:
determining a total presentation length time duration in X minutes for at least one of the plurality of presentation lengths;
determining points of interest for the presentation length; and
evaluating presentation length portions comprising at least a time duration of each point of interest of the presentation length.

9. The method of claim 8, wherein the points of interest include at least one of a presentation length transition, an automation event, and an extreme event.

10. The method of claim 9, wherein the extreme event comprises at least one of a quietest point and a loudest point.

11. The method of claim 8, further comprising the step of evaluating a center portion of the presentation length.

12. The method of claim 11, wherein the center portion comprises a duration of time from between about 0.45(X) minutes to about 0.55(X) minutes of the presentation length.

13. The method of claim 8, wherein the presentation length portions include a buffer portion before and after each point of interest.

14. The method of claim 8, wherein the presentation length portion comprises a duration of time from about 0.05(X) minutes prior to the point of interest to about 0.05(X) minutes after the point of interest.

15. A method for evaluating a digital cinema presentation comprising a plurality of presentation lengths comprising the steps of:
determining a total presentation length time duration in X minutes for each presentation length;
determining points of interest for the presentation, wherein the points of interest include at least one of a presentation length transition, an automation event, and an extreme event;
evaluating point of interest presentation length portions comprising at least a time duration of each point of interest and a buffer portion before and after each point of interest; and
evaluating a center presentation length portion, wherein the center presentation length portion comprises a duration of time substantially in the center of each presentation length.

16. The method of claim 15, wherein the center presentation length portion comprises a time duration from between about 0.45(X) minutes to about 0.55(X) minutes of each presentation length.

17. The method of claim 15, wherein each point of interest presentation length portion comprises a duration of time from about 0.05(X) minutes prior to the point of interest to about 0.05(X) minutes after the point of interest.
